(19) United States
(12) Patent Application Publication
(10) Pub. No.: US 2021/0313867 A1
(43) Pub. Date: Oct. 7, 2021

(54) TUBULAR LINEAR MOTOR

(71) Applicant: KYB Corporation, Tokyo (JP)

(72) Inventors: Yoshiaki KANO, Nagoya-shi, Aichi (JP); Kousuke SATOU, Tokyo (JP); Shinichirou HAKAMADA, Tokyo (JP)

(73) Assignee: KYB Corporation, Tokyo (JP)

(21) Appl. No.: 17/274,492

(22) PCT Filed: Mar. 25, 2019
(86) PCT No.: PCT/JP2019/012440

§ 371 Date: Mar. 9, 2021

(30) Foreign Application Priority Data
Oct. 19, 2018 (JP) 2018-197261

(51) Int. Cl. H02K 41/03

(52) U.S. Cl. CPC H02K 41/031; H02K 2213/03

(57) ABSTRACT

A tubular linear motor according to the present invention includes a core having a plurality of teeth having a tubular shape and provided on an outer periphery at equal intervals in an axial direction, winding wires of three phases of U-phase, V-phase, and W-phase mounted in slots between the teeth and of the core, and a field magnet having a tubular shape, in which the core is inserted inward so as to be movable in the axial direction, and a north magnetic pole and a south magnetic pole are alternately disposed on the inner periphery side in the axial direction, the field magnet has a yoke between the magnetic poles and in the axial direction, and the tubular linear motor has a two-pole 6n slot structure in which 6n slots are facing two poles, provided that n is an integer of 1 or more.

### TECHNICAL FIELD

The present invention relates to a tubular linear motor.

### BACKGROUND ART

As a tubular linear motor disclosed in JP 2008-253130 A, for example, a tubular linear motor includes: an armature having a tubular yoke, a core including a plurality of teeth disposed in a row on an outer periphery of the yoke in an axial direction, and winding wires of U-phase, V-phase, and W-phase mounted in slots between the teeth; and a mover including a base having a cylindrical shape provided on an outer periphery of the armature and a plurality of permanent magnets attached to an inner periphery of the base such that a south pole and a north pole are alternately arranged in the axial direction.

In a tubular linear motor configured in this manner, a permanent magnet of the mover is attracted, and the mover is driven in the axial direction with respect to the armature when current is conducted through the winding wires of U-phase, V-phase, and W-phase of the armature as appropriate.

### SUMMARY OF INVENTION

In the above-described tubular linear motor, a pitch of teeth of the core and a pitch of magnetic poles of the magnet are different from each other, and therefore, reluctance thrust is difficult to be generated, and thrust is difficult to be improved.

Therefore, an object of the present invention is to provide a tubular linear motor capable of improving thrust.

In order to achieve the above object, a tubular linear motor according to the present invention includes a core having a plurality of teeth having a tubular shape and provided on an outer periphery at equal intervals in an axial direction, winding wires of three phases of U-phase, V-phase, and W-phase mounted in slots between the teeth of the core, and a field magnet having a tubular shape, in which the core is inserted inward so as to be movable in the axial direction, and a north magnetic pole and a south magnetic pole are alternately disposed on an inner periphery side in the axial direction, the field magnet has a yoke or an air gap between the magnetic poles in the axial direction, and the tubular linear motor has a two-pole 6n slot structure in which 6n slots are facing two poles, provided that n is an integer of 1 or more.

### BRIEF DESCRIPTION OF DRAWINGS

FIG. 1 is a longitudinal sectional view of a tubular linear motor according to an embodiment.

FIG. 2 is a partially enlarged longitudinal sectional view of the tubular linear motor according to an embodiment in a state where a core and a field magnet are directly facing each other.

FIG. 3 is a diagram illustrating a state where a core of the tubular linear motor according to an embodiment is displaced from the state illustrated in FIG. 2 to left with respect to the field magnet.

FIG. 4 is a longitudinal sectional view of a core and field magnet of a tubular linear motor according to a first modification of an embodiment.

FIG. 5 is a longitudinal sectional view of a core and field magnet of a tubular linear motor according to a second modification of an embodiment.

FIG. 6 is a longitudinal sectional view of a core and field magnet of a tubular linear motor according to a third modification of an embodiment.

FIG. 7 is a longitudinal sectional view of a core and field magnet of a tubular linear motor according to a fourth modification of an embodiment.

### DESCRIPTION OF EMBODIMENTS

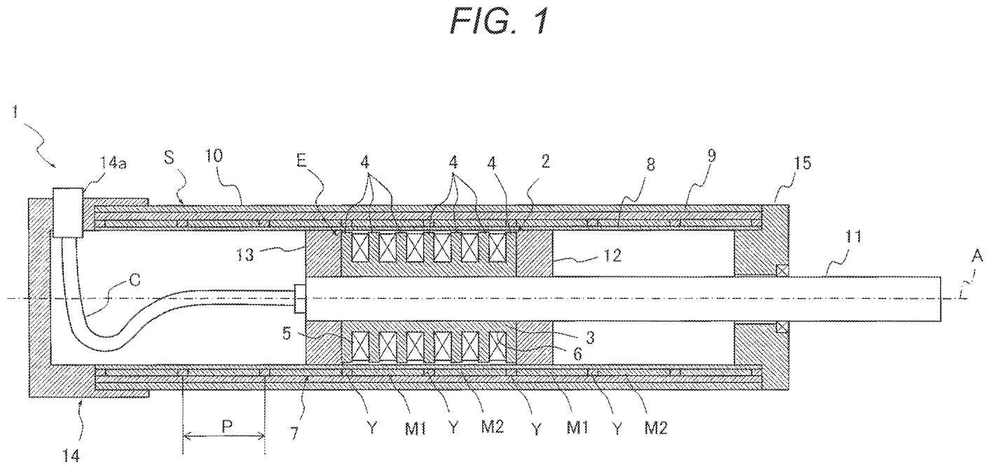

Hereinafter, the present invention will be described on the basis of an embodiment illustrated in the figures. As illustrated in FIG. 1, a tubular linear motor 1 according to an embodiment includes a core 2 having a plurality of teeth 4 having a tubular shape and provided on an outer periphery at equal intervals in an axial direction, winding wires 5 of three phases of U-phase, V-phase, and W-phase mounted in slots 6 between the teeth 4 and 4 of the core 2, and a field magnet 7 having a tubular shape, in which the core 2 is inserted inward so as to be movable in the axial direction, and a north pole and a south pole are alternately disposed on an inner periphery side in the axial direction.

Hereinafter, each part of the tubular linear motor 1 will be described in detail. The core 2 is set to be a mover in the present embodiment and includes a core main body 3 having a cylindrical shape, and a plurality of teeth 4 having an annular shape and provided on an outer periphery of the core main body 3 at intervals in the axial direction.

The core main body 3 has a cylindrical shape as described above. Furthermore, thickness of the core main body 3 is ensured such that a cross-sectional area of the core main body 3 is equal to or more than an area of a cross section of any portion from an inner periphery to an outer periphery of the teeth 4, the cross section being formed when the teeth 4 are cut into a cylinder centered on an axis A of the core 2 (refer to FIG. 1).

In the present embodiment, as illustrated in FIG. 1, seven teeth 4 are provided in a row on the outer periphery of the core main body 3 at equal intervals in the axial direction, and a slot 6 is formed between the teeth 4 and 4, the slot 6 including an air gap in which a winding wire 5 is mounted. It should be noted that, although the teeth 4 have a rectangular sectional shape having the same length in the axial direction (width) from the inner periphery to the outer periphery in the present embodiment, the sectional shape may be trapezoidal, and width on the inner periphery may be more than a width on the outer periphery to ensure a large cross-sectional area of a magnetic path on an inner periphery side.

Furthermore, in the present embodiment, a total of six slots 6, each including an air gap, are provided between adjacent teeth 4 and 4 in FIG. 1. Then, a winding wire 5 is wound and mounted in a slot 6. The winding wires 5 are mounted in a manner of one phase per one slot 6 in an order of W-phase, U-phase, and V-phase. In the tubular linear motor 1, an armature E includes the core 2 and the winding wires 5.

Then, the core 2 configured in this manner is mounted on an outer periphery of a rod 11 formed of a non-magnetic body, which is an output shaft. Specifically, the core 2 is fixed to the rod 11 by being held by sliders 12 and 13 of which right end and left end are fixed to the rod 11 in FIG. 1, the sliders 12 and 13 having an annular shape.

Meanwhile, in the present embodiment, a stator S includes an outer tube 10 formed of a cylindrical non-magnetic body, a back yoke 9 formed of a cylindrical magnetic body inserted into the outer tube 10, an inner tube 8 that is a cylindrical non-magnetic body forming an annular clearance with the back yoke 9, and a field magnet 7 having a tubular shape and inserted into the annular clearance between the back yoke 9 and the inner tube 8.

The field magnet 7 includes a plurality of first magnetic poles M1 of north pole having an annular shape and including a plurality of permanent magnets having a north pole on an inner periphery side, a plurality of second magnetic poles M2 of south pole having an annular shape and including a plurality of permanent magnets having a south pole on an inner periphery side, and a plurality of yokes Y having an annular shape, and the field magnet 7 is formed such that the first magnetic pole M1 and the second magnetic pole M2 are stacked alternately with the yoke Y in between. That is, while the yoke Y is interposed between the first magnetic pole M1 and the second magnetic pole M2, the first magnetic pole M1 and the second magnetic pole M2 are alternately disposed from one end of the tubular linear motor 1 in the axial direction. Therefore, in the field magnet 7, a north pole of the first magnetic pole M1 and a south pole of the second magnetic pole M2 appear alternately on the inner periphery side. Furthermore, a length of the first magnetic pole M1 in the axial direction and a length of the second magnetic pole M2 in the axial direction are both equal, and a two-magnetic pole pitch 2P, which is twice a length of a magnetic pole pitch P, is equal to a length of the core 2 in the axial direction.

The inner tube 8 has a tubular shape, is formed of a non-magnetic body, and is fitted to an inner periphery of the field magnet 7. Furthermore, the sliders 12 and 13 are in sliding contact with an inner periphery of the inner tube 8, and, by the sliders 12 and 13, the armature E can move smoothly in the axial direction together with the rod 11 without being eccentric with respect to the field magnet 7. The inner tube 8 forms a gap between an outer periphery of the core 2 and the inner periphery of the field magnet 7, and, along with the sliders 12 and 13, plays a role of guiding movement of the core 2 in the axial direction. It should be noted that, although the inner tube 8 is only required to be formed of a non-magnetic body, if the inner tube 8 is formed of synthetic resin, an effect of improving mass thrust density of the tubular linear motor 1 is enhanced. Here, the mass thrust density is a value obtained by dividing maximum thrust of the tubular linear motor 1 having the above-described configuration by mass of the tubular linear motor 1. Furthermore, since the inner tube 8 prevents the core 2 from being attracted to the field magnet 7 when the core 2 is inserted into the field magnet 7, favorable assembly property can be achieved. It should be noted that, although there are many advantages to providing the inner tube 8, it is possible to omit the inner tube 8.

Although the inner tube 8 may be a non-magnetic body of metal, in a case where the inner tube 8 is a non-magnetic body of metal, eddy current is generated inside the inner tube 8 when the armature E moves in the axial direction, and force hindering movement of the armature E is generated. Meanwhile, eddy current is not generated if the inner tube 8 is made of synthetic resin, and therefore, thrust of the tubular linear motor 1 can be improved more effectively, and mass of the tubular linear motor 1 can be reduced. It should be noted that, in a case where the inner tube 8 is made of synthetic resin, friction and abrasion between the sliders 12 and 13 can be reduced if the inner tube 8 is manufactured by using fluororesin. Furthermore, the inner tube 8 may be formed of another synthetic resin, or the inner periphery of the inner tube 8 formed of another synthetic resin may be coated with fluororesin in order to reduce friction and abrasion.

The back yoke 9 has a tubular shape and is formed of a magnetic body, and together with the yoke Y, forms a magnetic path between the first magnetic pole M1 and the second magnetic pole M2. The length of the back yoke 9 in the axial direction is only required to be equal to or longer than the total length of the field magnet 7. It should be noted that, although the back yoke 9 can be omitted, if the back yoke 9 is provided, leakage of magnetic flux lines of the first magnetic pole M1 and second magnetic pole M2 to outside is reduced, and reduction in strength of a magnetic field on an inner periphery side of the field magnet 7 is suppressed, and therefore, thrust of the tubular linear motor 1 can be improved.

Furthermore, in the present embodiment, the outer tube 10 is provided on the outer periphery of the back yoke 9. The outer tube 10 is formed of a non-magnetic body, and magnetic force of the field magnet 7 prevents a contaminant such as iron sand from adhering to an outer periphery of the outer tube 10. It should be noted that, in a case the tubular linear motor 1 is configured such that load, which is received by the tubular linear motor 1, is received by the back yoke 9, the outer tube 10 may be omitted.

Then, left ends of the outer tube 10, back yoke 9, and inner tube 8 in FIG. 1 are closed by a cap 14, and right ends of the outer tube 10, back yoke 9, and inner tube 8 in FIG. 1 are closed by a head cap 15 having an annular shape and guiding movement of the rod 11 in the axial direction, the rod 11 being inserted into an inner periphery.

It should be noted that the cap 14 includes a connector 14a that connects a cable C connected to the winding wires 5 to an external power supply (not illustrated) so that the winding wires 5 can be energized by the external power supply. Furthermore, lengths of the outer tube 10 and inner tube 8 in the axial direction are longer than the length of the core 2 in the axial direction, and the core 2 can be stroked in a horizontal direction in FIG. 1 within a range of length of the field magnet 7 in the axial direction.

Then, for example, if an electric angle of the winding wires 5 with respect to the field magnet 7 is sensed, a conducting phase is switched on the basis of the electric angle, and current amount of each of the winding wires 5 is controlled with PWM control, thrust and a movement direction of the armature E in the tubular linear motor 1 can be controlled. It should be noted that the above-described control method is an example and is not limited to this. Thus, in the tubular linear motor 1 according to the present embodiment, the armature E behaves as a mover, and the field magnet 7 behaves as a stator. Furthermore, in a case where external force that relatively displaces the armature E and the field magnet 7 in the axial direction acts, current conduction to the winding wires 5 or induced electromotive force generated in a winding wire 5 may generate thrust that reduces the relative displacement and cause the tubular linear motor 1 to dampen vibration or motion of an apparatus caused by the external force, and energy regeneration that generates power from external force is also possible.

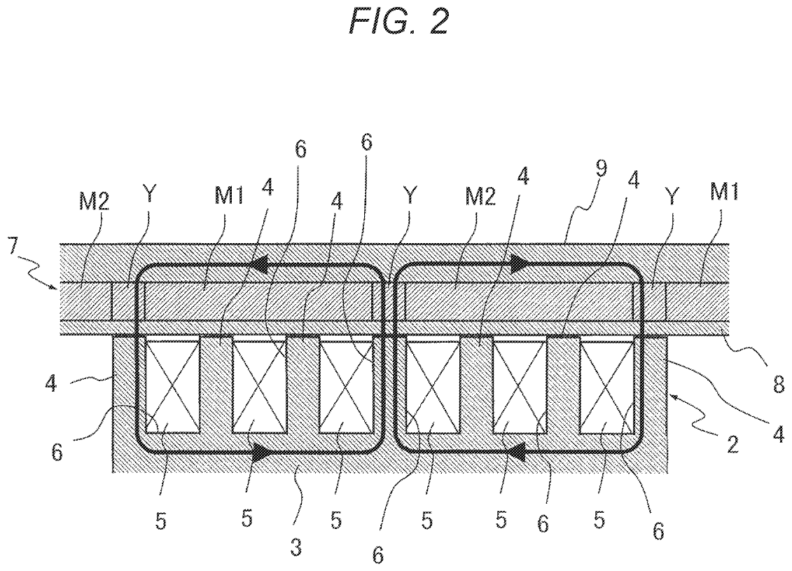

The tubular linear motor 1 is configured as described above, and operation of the tubular linear motor 1 will be described next. As described above, each of the lengths of the first magnetic pole M1 and second magnetic pole M2 in the axial direction is equal to the length in the axial direction from one end to another end of three adjacent slots 6 in the core 2. Therefore, as illustrated in FIG. 2, when three adjacent slots 6 of the core 2 (three slots 6 on left half of the core 2 in FIG. 2) directly face the first magnetic pole M1, each of teeth 4 positioned at both ends of these three slots 6 directly faces each of yokes Y at both sides of the first magnetic pole M1 in the axial direction in the field magnet 7. Thus, when the three slots 6 on the left half of the core 2 directly face the first magnetic pole M1, three slots 6 on right half of the core 2 directly face the second magnetic pole M2. That is, the three adjacent slots 6 on the right half of the core 2 directly face the second magnetic poles M2, and each of teeth 4 positioned at the both ends of these three slots 6 directly faces each of yokes Y at both sides of the second magnetic pole M2 in the axial direction in the field magnet 7. That is, the tubular linear motor 1 according to the present embodiment is a two-pole, six-slot linear motor in which six slots 6 are facing two magnetic poles of the field magnet 7.

As illustrated in FIG. 2, a magnetic flux of the first magnetic pole M1 passes in a loop through the yokes Y at both sides of the first magnetic poles M1 and the back yoke 9 in the axial direction, the teeth 4 and 4 at both sides of the three adjacent slots 6 on the left half of the core 2 in the axial direction, and the core main body 3. Meanwhile, a magnetic flux of the second magnetic pole M2 passes in a loop through the yokes Y at both sides of the second magnetic pole M2 and the back yoke 9 in the axial direction, the teeth 4 and 4 at both sides of the three adjacent slots 6 on the right half of the core 2 in the axial direction, and the core main body 3.

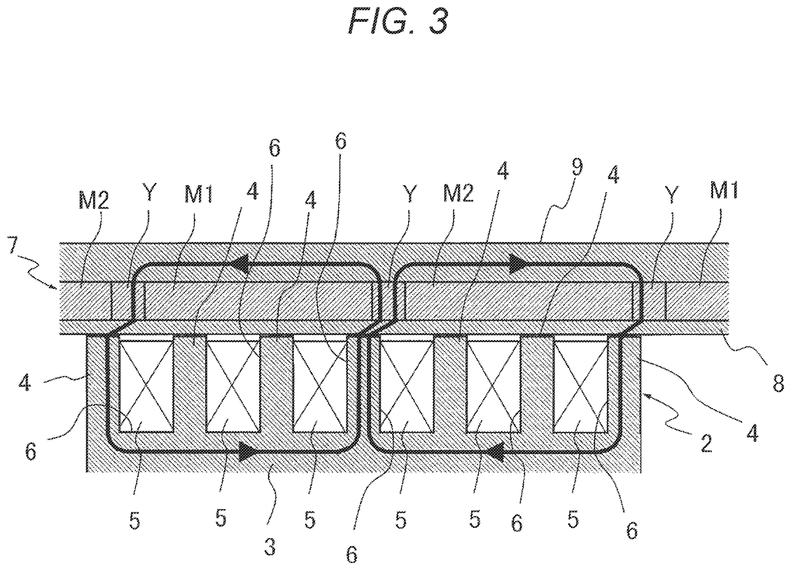

If the core 2 in the state illustrated in FIG. 2 is displaced to left with respect to the field magnet 7 in the state illustrated in FIG. 3, the teeth 4 directly facing the yokes Y in FIG. 2 are displaced to the left, and therefore, magnetic force of the first magnetic pole M1 and second magnetic pole M2 generates reluctance thrust that attracts the teeth 4 to a position illustrated in FIG. 2.

Thus, in the tubular linear motor 1 according to the present invention, the teeth 4 of the core 2 become salient poles and are attracted to the field magnet 7, by which reluctance thrust is generated, and therefore, reluctance thrust can be obtained in addition to magnetic thrust that can be obtained by conducting current through the winding wires 5. In order to obtain reluctance thrust, it is only required to provide saliency to the field magnet 7 in the axial direction and provide a portion where magnetic resistance is low between the magnetic poles M1 and M2 and arrange at least six slots 6 to directly face the two magnetic poles, to arrange one or more units of slots 6 to directly face the two magnetic poles provided that six slots 6 are regarded as one unit, and to provide a core 2 having the total length an integral multiple of the two-magnetic pole pitch 2P. Therefore, provided that n is an integer of 1 or more, the tubular linear motor 1 can exert reluctance thrust if 6n number of slots 6 are arranged to directly face the two magnetic poles.

As described above, the tubular linear motor 1 according to the present invention includes the core 2 having the plurality of teeth 4 having a tubular shape and provided on an outer periphery at equal intervals in the axial direction, the winding wires 5 of three phases of U-phase, V-phase, and W-phase mounted in slots 6 between teeth 4 and 4 of the core 2, and the field magnet 7 having a tubular shape, in which the core 2 is inserted inward so as to be movable in the axial direction, and the magnetic pole M1 of north pole and the magnetic pole M2 of south pole are alternately disposed on the inner periphery side in the axial direction, the field magnet 7 has the yoke Y between the magnetic poles M1 and M2 in the axial direction, and the tubular linear motor 1 has a two-pole 6n slot structure in which 6n slots are facing two poles, provided that n is an integer of 1 or more. According to the tubular linear motor 1 configured in this manner, reluctance thrust can be obtained in addition to magnetic thrust that can be obtained by conducting current through the winding wires 5, and therefore, thrust can be improved.

Furthermore, because the tubular linear motor 1 according to the present embodiment includes the back yoke 9 having a tubular shape on the outer periphery of the field magnet 7, leakage of a magnetic flux line of the field magnet 7 to outside can be reduced, and therefore, thrust can be even more improved.

As described above, in order to obtain reluctance thrust, the field magnet 7 is provided with saliency in the axial direction. In order to provide saliency to the field magnet 7, a permanent magnet may be embedded in a magnetic body to form a yoke between magnetic poles or may provide an air gap, in addition to interposing a yoke Y having an annular shape between a permanent magnet of the first magnetic pole M1 and a permanent magnet of the second magnetic pole M2 of south pole.

Furthermore, because the length of the core 2 in the axial direction is equal to the length of the two-magnetic pole pitch 2P in the tubular linear motor 1 according to the present embodiment, the length of the core 2 in the axial direction is suitable for geometrically obtaining reluctance thrust, and therefore, reluctance thrust can be efficiently obtained.

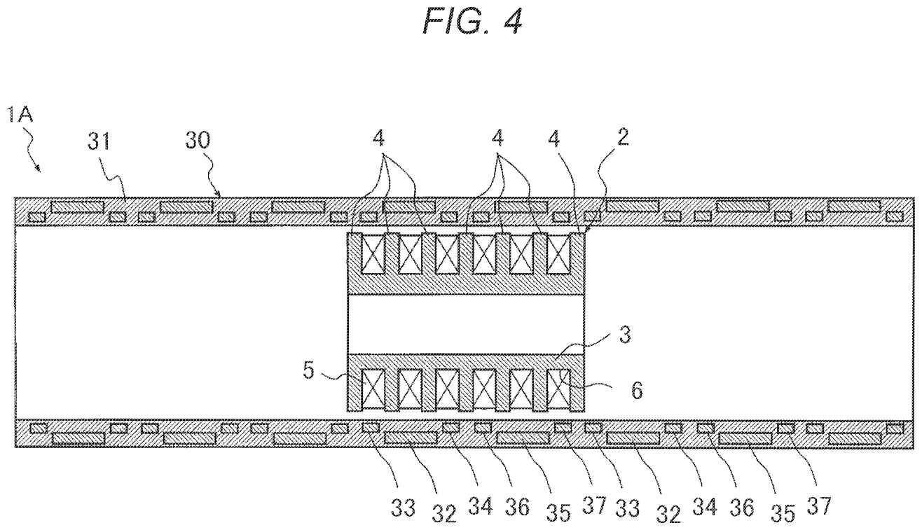

Specifically, a field magnet may be configured as in a tubular linear motor 1A of a first modification, a tubular linear motor 1B of a second modification, a tubular linear motor 10 of a third modification, and a tubular linear motor 1D of a fourth modification, which are according to an embodiment and illustrated in FIGS. 4 to 7, respectively.

It should be noted that the tubular linear motors 1A, 1B, 1C, and 1D differ from the tubular linear motor 1 only in configuration of a field magnet. In FIGS. 4 to 7, only a core 2 and field magnet of the tubular linear motors 1A, 1B, 1C, and 1D are illustrated, and illustration of other configurations, which are similar to configurations of the tubular linear motor 1, are omitted.

A field magnet 30 of the tubular linear motor 1A of the first modification illustrated in FIG. 4 includes a thick tubular member 31 formed of a magnetic body and permanent magnets 32, 33, 34, 35, 36, and 37 having an annular shape and embedded in thickness of the tubular member 31. The permanent magnet 32 is an annular permanent magnet having a north pole on an inner periphery, the permanent magnet 33 is an annular permanent magnet having a north pole on a right end side in FIG. 4 and a south pole on a left end side in FIG. 4, and the permanent magnet 34 is an annular permanent magnet having a south pole on a right end side in FIG. 4 and a north pole on a left end side in FIG. 4. Then, the permanent magnet 32 is disposed with a north pole thereof facing an inner periphery side, on an outer periphery of space between the permanent magnet 33 and the permanent magnet 34 disposed such that north poles thereof are facing each other in the axial direction, and these permanent magnets 32, 33, and 34 form one north magnetic pole.

The permanent magnet 35 is an annular permanent magnet having a south pole on an inner periphery, the permanent magnet 36 is an annular permanent magnet having a south pole on a right end side in FIG. 4 and a north pole on a left end side in FIG. 4, and the permanent magnet 37 is an annular permanent magnet having a north pole on a right end side in FIG. 4 and a south pole on a left end side in FIG. 4. Then, the permanent magnet 35 is disposed with a south pole thereof facing an inner periphery side, on an outer periphery of space between the permanent magnet 36 and the permanent magnet 37 disposed such that south poles thereof are facing each other in the axial direction, and these permanent magnets 35, 36, and 37 form one south magnetic pole. These permanent magnets 35, 36, and 37 form one south magnetic pole.

The tubular member 31 is a thick cylinder formed of a magnetic body, and the permanent magnets 32, 33, and 34 forming a north magnetic pole and the permanent magnets 35, 36, and 37 forming a south magnetic pole are alternately disposed for each magnetic pole in the axial direction and embedded in thickness. It should be noted that the tubular member 31 is formed by combining split bodies and the permanent magnets 32, 33, 34, 35, 36, and 37 can be embedded in the tubular member 31.

In the field magnet 30 configured in this manner, a north magnetic pole and a south magnetic pole appear in an inner periphery side in the axial direction, and, in an inner periphery side of the field magnet 30, a magnetic body of the tubular member 31 is disposed between the permanent magnets 33 and 34 at a terminal end of the north magnetic pole and the permanent magnets 36 and 37 at a terminal end of the south magnetic pole to form a yoke between the magnetic poles. Therefore, the field magnet 30 has saliency on an inner periphery in the axial direction. The tubular linear motor 1A is a two-pole six-slot linear motor in which six slots 6 of the core 2 are facing the two magnetic poles in such a field magnet 30, and the field magnet 30 exerts attraction so as to cause three consecutive slots 6 of the core 2 to directly face the magnetic poles according to a positional relation of the core 2 with respect to the field magnet 30. Therefore, with the tubular linear motor 1A configured in this manner, reluctance thrust can be obtained in addition to magnetic thrust that can be obtained by conducting current through the winding wires 5, and therefore, thrust can be improved.

In a case where the field magnet 30 is configured as illustrated in FIG. 4, reluctance thrust can be improved because a flow of a q-axis magnetic flux is improved, and a lower manufacturing cost can be achieved because the permanent magnets 32, 33, 34, 35, 36, and 37 having an annular shape and a rectangular cross section can be adopted, and a magnet size can be smaller than permanent magnets M1 and M2 in the tubular linear motor 1.

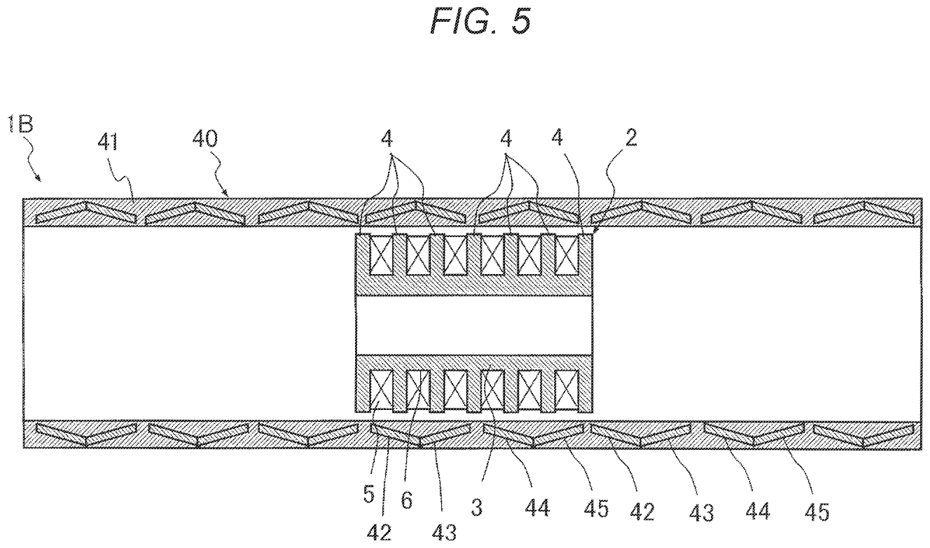

Furthermore, a field magnet 40 of the tubular linear motor 1B of the second modification illustrated in FIG. 5 includes a thick tubular member 41 formed of a magnetic body and permanent magnets 42, 43, 44, and 45 having an annular shape and embedded in thickness of the tubular member 41. The permanent magnet 42 is a permanent magnet having a conical shape with a diameter of one end smaller than a diameter of another end and having a north pole on an inner periphery, and the permanent magnet 43 is a permanent magnet having a shape identical to a shape of the permanent magnet 42 and having a north pole on an inner periphery. Then, the permanent magnet 42 and the permanent magnet 43 are embedded in the tubular member 41 with ends on a large diameter side abutting each other, and these permanent magnets 42 and 43 form one north magnetic pole.

The permanent magnet 44 is a permanent magnet having a conical shape with a diameter of one end smaller than a diameter of another end and having a south pole on an inner periphery, and the permanent magnet 45 is a permanent magnet having a shape identical to a shape of the permanent magnet 44 and having a south pole on an inner periphery. Then, the permanent magnet 44 and the permanent magnet 45 are embedded in the tubular member 41 with ends on a large diameter side abutting each other, and these permanent magnets 44 and 45 form one south magnetic pole.

The tubular member 41 is a thick cylinder formed of a magnetic body, and the permanent magnets 42 and 43 forming a north magnetic pole and the permanent magnets 44 and 45 forming a south magnetic pole are alternately disposed for each magnetic pole in the axial direction and embedded in thickness. It should be noted that the tubular member 41 is formed by combining split bodies and the permanent magnets 42, 43, 44, and 45 can be embedded in the tubular member 41.

In the field magnet 40 configured in this manner, a north magnetic pole and a south magnetic pole appear in an inner periphery side in the axial direction, and, in an inner periphery side of the field magnet 40, a magnetic body of the tubular member 41 is disposed between the permanent magnets 42 and 43 of north magnetic pole and the permanent magnets 44 and 45 of south magnetic pole to form a yoke between the magnetic poles. Therefore, the field magnet 40 has saliency on an inner periphery in the axial direction. The tubular linear motor 1B is a two-pole six-slot linear motor in which six slots 6 of the core 2 are facing the two magnetic poles in such a field magnet 40, and the field magnet 40 exerts attraction so as to cause three consecutive slots 6 of the core 2 to directly face the magnetic poles according to a positional relation of the core 2 with respect to the field magnet 40. Therefore, with the tubular linear motor 1B configured in this manner, reluctance thrust can be obtained in addition to magnetic thrust that can be obtained by conducting current through the winding wires 5, and therefore, thrust can be improved.

In a case where the field magnet 40 is configured as illustrated in FIG. 5, reluctance thrust can be more improved because a flow of a q-axis magnetic flux is improved further than in a case of the field magnet 30 illustrated in FIG. 4. With the field magnet 40, a lower manufacturing cost can be achieved because the permanent magnets 42, 43, 44, and 45 having a magnet size smaller than a size of the permanent magnets M1 and M2 of the tubular linear motor 1 can be utilized.

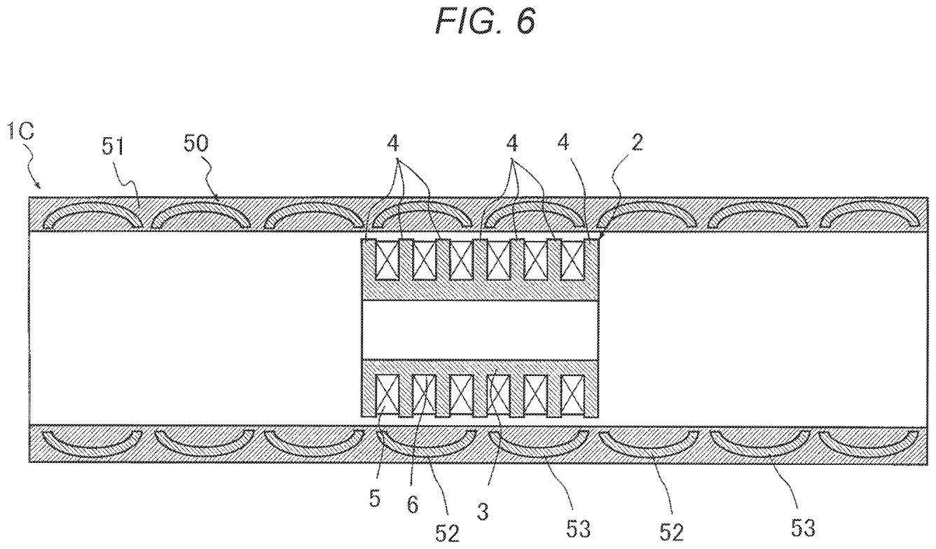

Moreover, a field magnet 50 of the tubular linear motor 1C of the third modification illustrated in FIG. 6 includes a thick tubular member 51 formed of a magnetic body and permanent magnets 52 and 53 having an annular shape and embedded in thickness of the tubular member 51. The permanent magnet 52 is a permanent magnet having an annular shape and a semicircular cross section with a diameter increasing toward a center in the axial direction, and having a north pole on an inner periphery. Then, the permanent magnet 52 is embedded in the tubular member 51 and forms one north magnetic pole.

The permanent magnet 53 is a permanent magnet having an annular shape and a semicircular cross section with a diameter increasing toward a center in the axial direction, and having a south pole on an inner periphery. Then, the permanent magnet 53 is embedded in the tubular member 51 and forms one south magnetic pole.

The tubular member 51 is a thick cylinder formed of a magnetic body, and the permanent magnet 52 forming a north magnetic pole and the permanent magnet 53 forming a south magnetic pole are alternately disposed for each magnetic pole in the axial direction and embedded in thickness. It should be noted that the tubular member 51 is formed by combining split bodies and the permanent magnets 52 and 53 can be embedded in the tubular member 51.

In the field magnet 50 configured in this manner, a north magnetic pole and a south magnetic pole appear in an inner periphery side in the axial direction, and, in an inner periphery side of the field magnet 50, a magnetic body of the tubular member 51 is disposed between the permanent magnet 52 of north magnetic pole and the permanent magnet 53 of south magnetic pole to form a yoke between the magnetic poles. Therefore, the field magnet 50 has saliency on an inner periphery in the axial direction. The tubular linear motor 1C is a two-pole six-slot linear motor in which six slots 6 of the core 2 are facing the two magnetic poles in such a field magnet 50, and the field magnet 50 exerts attraction so as to cause three consecutive slots 6 of the core 2 to directly face the magnetic poles according to a positional relation of the core 2 with respect to the field magnet 50. Therefore, with the tubular linear motor 1C configured in this manner, reluctance thrust can be obtained in addition to magnetic thrust that can be obtained by conducting current through the winding wires 5, and therefore, thrust can be improved.

In a case where the field magnet 50 is configured as illustrated in FIG. 6, reluctance thrust can be even more improved because a flow of a q-axis magnetic flux is improved further than in a case of the field magnet 40 illustrated in FIG. 5. With the field magnet 50, a lower manufacturing cost can be achieved because the permanent magnets 52 and 53 having a magnet size smaller than a size of the permanent magnets M1 and M2 of the tubular linear motor 1 can be utilized.

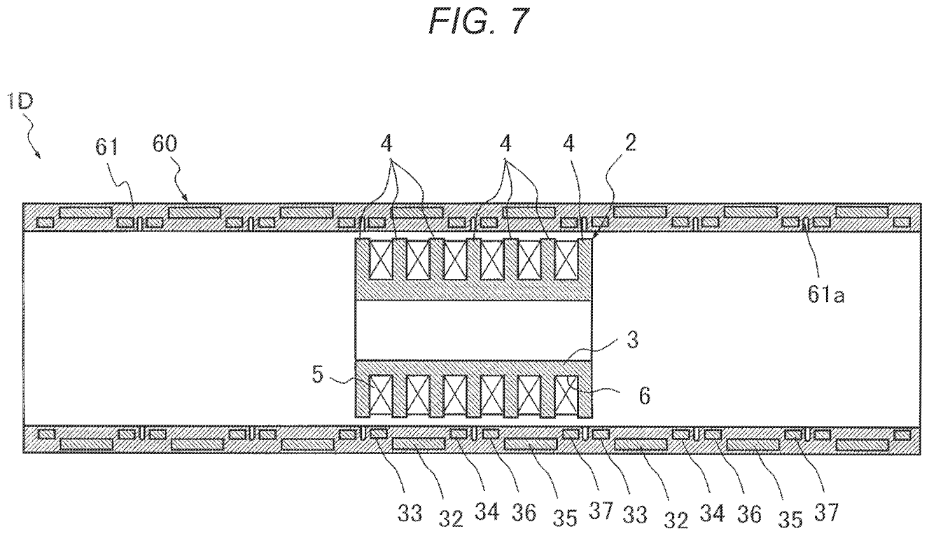

A field magnet 60 of the tubular linear motor 1D of the fourth modification illustrated in FIG. 7 includes a thick tubular member 61 formed of a magnetic body and permanent magnets 32, 33, 34, 35, 36, and 37 having an annular shape and embedded in thickness of the tubular member 61. The permanent magnets 32, 33, 34, 35, 36, and 37 have a configuration similar to a configuration of the tubular linear motor 1A illustrated in FIG. 4, and the permanent magnets 32, 33, and 34 form one north magnetic pole, and the permanent magnets 35, 36, 37 form one south magnetic pole.

Moreover, in the field magnet 60 illustrated in FIG. 7, a slit 61a having an annular shape is provided between the permanent magnets 32 and 37 and between the permanent magnets 34 and 36, which are an inner periphery of a tubular member 61 and are between magnetic poles, and a north magnetic pole and a south magnetic pole are separated by the slit 61a.

In the field magnet 60 configured in this manner, a north magnetic pole and a south magnetic pole appear in an inner periphery side in the axial direction, and, in an inner periphery side of the field magnet 60, an air gap including the slit 61a is formed between the permanent magnets 32 and 34 at a terminal end of the north magnetic pole and the permanent magnets 36 and 37 at a terminal end of the south magnetic pole. Therefore, the field magnet 60 has saliency on an inner periphery in the axial direction. The tubular linear motor 1D is a two-pole six-slot linear motor in which six slots 6 of the core 2 are facing the two magnetic poles in such a field magnet 60, and the field magnet 60 exerts attraction so as to cause three consecutive slots 6 of the core 2 to directly face the magnetic poles according to a positional relation of the core 2 with respect to the field magnet 60. Therefore, with the tubular linear motor 1D configured in this manner, reluctance thrust can be obtained in addition to magnetic thrust that can be obtained by conducting current through the winding wires 5, and therefore, thrust can be improved.

In a case where the field magnet 60 is configured as illustrated in FIG. 7, as compared to the field magnet 30 illustrated in FIG. 4, reluctance thrust can be improved with improved saliency, magnetic thrust can be improved by a flux barrier reducing leakage magnetic flux between a north pole magnet and a south pole magnet, and a total thrust of the tubular linear motor 1D can be improved as compared to the tubular linear motor 1A.

Although a preferred embodiment of the present invention has been described in detail above, alterations, modifications, and changes can be made without departing from the scope of the claims.

This application claims priority based on Japanese Patent Application No. 2018-197261 filed with the Japan Patent Office on Oct. 19, 2018, and the entire contents of this application are incorporated herein by reference.

1. A tubular linear motor comprising:
a core having a plurality of teeth having a tubular shape and provided on an outer periphery at equal intervals in an axial direction;
winding wires of three phases of U-phase, V-phase, and W-phase mounted in slots between the teeth of the core; and
a field magnet having a tubular shape, in which the core is inserted inward so as to be movable in the axial direction, and a north magnetic pole and a south magnetic pole are alternately disposed on an inner periphery side in the axial direction,
wherein the field magnet has a yoke or an air gap between the magnetic poles in the axial direction, and
the tubular linear motor has a two-pole 6n slot structure in which 6n slots are facing two poles, provided that n is an integer of 1 or more.

2. The tubular linear motor according to claim 1, further comprising
a back yoke having a tubular shape on an outer periphery of the field magnet.

3. The tubular linear motor according to claim 1,
wherein a length of the core in the axial direction is equal to a length of a two-magnetic pole pitch of the field magnet.

4. The tubular linear motor according to claim 1, wherein
the yoke is formed by a magnetic body of the tubular member formed of a magnetic body,
the north magnetic pole and a south magnetic pole are embedded in thickness of the tubular member,
the north magnetic pole includes:
a first permanent magnet that is an annular permanent magnet having a north pole on an inner periphery;
a second permanent magnet and a third permanent magnet that are provided on both sides of the first permanent magnet in the axial direction,
the second permanent magnet is an annular permanent magnet which has a smaller diameter than the first permanent magnet and has a north pole on the first permanent magnet side, and
the third permanent magnet is an annular permanent magnet which has a smaller diameter than the first permanent magnet and has a north pole on the first permanent magnet side,
the south magnetic pole includes:
a fourth permanent magnet that is an annular permanent magnet having a south pole on an inner periphery; and
a fifth permanent magnet and a sixth permanent magnet that are provided on both sides of the fourth permanent magnet in the axial direction,
the fifth permanent magnet is an annular permanent magnet which has a smaller diameter than the first permanent magnet and has a south pole on the first permanent magnet side, and
the sixth permanent magnet is an annular permanent magnet which has a smaller diameter than the first permanent magnet and has a south pole on the first permanent magnet side.

5. The tubular linear motor according to claim 4,
wherein the tubular member has slits provided between the north pole and the south pole of an inner periphery.

6. The tubular linear motor according to claim 1, wherein
the yoke is formed by a magnetic body of the tubular member formed of a magnetic body,
the north magnetic pole and a south magnetic pole are embedded in thickness of the tubular member,
the north magnetic pole includes:
a pair of seventh permanent magnets that is a permanent magnet having a cylindrical shape with a diameter of one end smaller than a diameter of another end and having a north pole on an inner periphery,
the pair of these seventh permanent magnets is embedded in the tubular member with ends on a large diameter side abutting each other,
the south magnetic pole includes:
a pair of eighth permanent magnets that is a permanent magnet having a cylindrical shape with a diameter of one end smaller than a diameter of another end and having a south pole on an inner periphery, and
the pair of these eighth permanent magnets is embedded in the tubular member with ends on a large diameter side abutting each other.

7. The tubular linear motor according to claim 1, wherein
the yoke is formed by a magnetic body of the tubular member formed of a magnetic body,
the north magnetic pole and a south magnetic pole are embedded in thickness of the tubular member,
the north magnetic pole includes:
a nineth permanent magnet that is a permanent magnet having an annular shape and an arc shape in cross section with a diameter increasing toward a center in the axial direction, and having a north pole on an inner periphery, and
the south magnetic pole includes:
a tenth permanent magnet that is a permanent magnet having an annular shape and an arc shape in cross section with a diameter increasing toward a center in the axial direction, and having a south pole on an inner periphery.
